(19) United States
(12) Patent Application Publication
(10) Pub. No.: US 2010/0202881 A1
(43) Pub. Date: Aug. 12, 2010

(54) DOWNWIND POWER PLANT, AND A METHOD FOR OPERATING A DOWNWIND POWER PLANT

(76) Inventors: Tor Anders Nygaard, As (NO); Christian Grorud, Oslo (NO)

Correspondence Address: WENDEROTH, LIND & PONACK, L.L.P., 1030 15th Street, N.W.,, Suite 400 East, Washington, DC, 20005-1503, US

(21) Appl. No.: 12/528,707

(22) PCT Filed: Feb. 26, 2008
(86) PCT No.: PCT/NO2008/000072

§ 371 Date: Apr. 15, 2010

(30) Foreign Application Priority Data
Feb. 28, 2007 (NO) 2007 1147

(51) Int. Cl. F03D 11/04; F03D 1/00

(52) U.S. Cl. 416/1; 416/85; 416/147

(57) ABSTRACT

The present invention concerns a downwind power plant (1) with at tower (2), a machine housing (3) and a turbine (4) supported in the housing (3). The turbine (4) defines a plane of revolution and is adapted to be pivoted to a position substantially perpendicular to the direction of the wind. At least two wires (6) are connected to the tower (2) at its one end, and each wire is attached in at least one attachment point in the other end for maintaining the tower in an erected position during operation. Each wire may include at least a first and a second position. The wire in the first position extends at an oblique angle downwards from an attachment point in or close to the centre for the horizontal forces that are applied to the tower by the turbine under operation. In the second position is each wire lead out of the plane of revolution, such that the turbine plane is free to turn around a vertical axis without the wire impeding the turbine plane. Furthermore, it is described a method for operating a downwind power plant of this type.

Downwind power plant, and a method for operating a downwind power plant

The present invention concerns a downwind wind power plant, and a method for operating a downwind wind power plant. In the wind power plant according to the invention, the axial force from the turbine is lead to the surface, for instance the seabed at the bottom of a body of water, from substantially the hub height of the turbine. This leads to a substantial unloading of the moment on the tower and the structure below the tower, compared to conventional wind power generators. The wind power generator includes a tower, a machine housing and a downwind turbine supported in the housing. The machine housing may also be an integrated part of the tower, or parts of the tower. The tower, or parts of it, may be pivoted with the turbine. During ordinary operation the wind power generator is held erected by at least one wire, that at the upwind side is attached with its one end in an upper position, to the upper part of the power or the machine housing, and at its other end to the surface, for instance at the bottom of a body of water. The wires at the downwind side are maintained at a lower, downward position to avoid conflict with the turbine.

A wind power plant is used to transform the kinetic energy of the wind to mechanical energy. This energy is thereafter transformed to electric energy. A standard wind power generator on land includes a tower that is fixed to the ground, with a machine housing at the top. To the machine housing it is attached an upwind turbine with horizontal axis that can pivot actively towards the wind. Many alternative embodiments are commercially available, but are relatively rarely used. From the 1980ies and up until today the size of the wind power generators have increased substantially, from some tenths of Kilowatts per unit up until units of 3-5 MW. At the same time, the cost per kWh has been substantially reduced. Today we have wind power parks both on shore and off shore. Most of the off shore installations are placed with the tower rigidly attached to the bottom on shallow waters. By placing wind power generators on deep waters, the available basis of the resources can be expanded, both because the areas are considerable and because the wind speed is higher. Esthetical conflicts and problems related to alternative use of areas are reduced substantially, and the risk of damaging lives and property is almost eliminated. Wind power generators at deep waters will for most practical purposes be kept erected by floating elements and are anchored to the sea bed.

Norwegian patent application no 2002 6179 describes a floating wind turbine that can freely pivot around an anchoring organ. A framework is attached to the tower and includes a strut between the tower and a further floating body, and a wire between the floating body and the upper part of the tower, such that the tower, the strut and the wire forms a triangle. Under certain operating conditions, if the direction of the bottom wire is in the elongation of the wire between the further floating element and the tower, a complete unloading of the moment of the tower may be achieved. The requirement for the floating body and a load will under these conditions be reduced considerably. Under other operating conditions one is referred to having a considerable straightening moment by means of considerable buoyancy and a lot of ballast.

Norwegian patent application no. 2002 5440, “Apparatus for providing windmills in a body of water and a method for providing the same”, describes a floating wind power generator attached to a sub frame. The sub frame includes a floating element and possibly a column attached below the floating element, where cables are attached to the tower of the wind power generator, the floating element and/or the column and to the sea bed. In two embodiments the cable is attached to the tower in the lower part of the turbine plane, and close to the machine housing respectively. In the latter situation it is assumed that the turbine plane is shifted a long distance out in a horizontal direction and/or that the cables are attached in a very sharp angle in relation to the tower. A sharp angel between the tower and the cables reduces the moment unloading and increases the requirements for buoyancy, load and/or tension in the bottom cables.

NO 317.431 describes a wind power generator that floats on deep waters and that is anchored to the sea bed with a torsionally stiff strut. The inclination of the tower is limited in that the centre of the buoyancy is above the joint centre of gravity of the structure. The considerable bending moment resulted from the actual force of the turbine, for instance about the central gravity of the structure, has to be balanced by the moment given by the buoyancy and the torque arm between the centre of buoyancy and the centre of gravity. The tension in the strut will not give any other contributions than that the buoyancy of the structure may be made greater than the weight of the structure.

WO 2004/097217 describes a variant of NO 317.431, where a swivel in the anchoring point at the sea bed allows the structure to rotate about the vertical axis, such that the wind turbine can be orientated downwind without a yaw mechanism. The conditions concerning inclination of the tower is as described in relation to NO 317.431.

WO 01/7392 describes a floating wind turbine attached to a barge, with several load tanks that can be filled/emptied to adjust the angle of inclination. Even if the tower above the water is unloaded by means of a line between the upper part of the tower and the barge, must still the entire moment of inclination caused by the axial force of the turbine be taken up by means of buoyancy and ballast.

All the publications mentioned above describe, with the exception of NO 2002 6179 and partly NO 2002 5440, various ways of designing floating wind power generators with ballast and floating elements and/or biased strained struts—to be able to take up the moment that is created by the axial forces of the turbine and the long lever arm that is created by the tower. The problems related to these solutions are that none of the concepts reduces the initial moment, they only describe various ways of counteracting it. The present invention overcomes this limitation by unloading the structure for the axial load, that acts at the height of the hub—and conveys this force via one or several cables to the surface, for instance to the bottom of a body of water. The advantage is that the entire structure can be dimensioned with a considerably less straightening moment, something that will lead to a considerably reduced weight.

Similarly to the present invention, it is in NO 2002 6179 described a wind power generator that is substantially unloaded in terms of moment by conveying axial forces from the turbine down to the bottom of a body of water. However, NO 2002 6179 is amongst other things characterized in that the wind power generator will move in a circle around a point of anchoring. The position of the turbine in this circle is determined by the, at any point in time, relevant wind direction. Repositioning along the circular path is time consuming and will therefore create production losses. Furthermore, the invention in NO 2002 6179 is characterized by a horizontal strut with a floating body at the end. This part of the structure is orientated perpendicular to the direction of the motion along the circular path, something that in all practical embodiments will give a considerable resistance against motion during the repositioning. Furthermore, this part of the structure will be exposed to considerable load imposed by waves. The turbine that is described in NO 2002 6179 does not have any substantially greater sideways stability than what is achieved with the self erecting moment of the structure. It is also a problem with this solution that every windmill will require a considerable area, depending on water depth, and this is problematic in particular when parks of windmills are to be used.

NO 2002 5440 shows in FIG. 6 an embodiment with attachment of cables to the bottom in the upper part of the tower. The conflict with turbine plane is not shown in the figure, but it is pointed out in the publication that the (turbine) housing must be extended in such an embodiment. This solution will act very limiting on the possibility to unload the moment in the tower and structure below it.

Most of the known concept studies for wind power in deep waters are based on the wind power stations being made as floating structures with an erecting moment that is sufficient to counteract the moment from the turbine during operation. For the described structures, more than 50% of the weight of the structure may be directly related to the need for an erecting moment. In one embodiment as a floating wind power station may the present invention give substantial reduction in the need for an erecting moment. This gives the possibility for a substantial weight and thereby cost reductions. Furthermore, the need for area is reduced in relation to stations moving in a circle.

The purpose of the present invention is to reduce the requirement for an erecting moment for the sub sea structure, by leading the horizontal force component of the turbine directly to the seabed, at the same time as the turbine can be pivoted without getting in conflict with the wire.

With the present invention the horizontal forces can be led away from the top of the tower, without imposing corresponding requirements to the design of the machine housing as in NO 2202 5440. As opposed to what is shown in NO 2002 6179, the present invention will enable achieving this without allowing the wind power station to float in a circular path around a point of anchoring. The present invention makes it possible to allow the wind power station to be situated in substantially the same position, and can be anchored to several points, such that it is achieved a considerable degree of stability sideways, with sideways placed anchoring wires tightened in a lower position.

The present invention concerns a downwind wind power generator with a tower, a machine housing and a turbine supported in the housing. The tower may be made of steel, aluminium, composite materials, concrete or other suitable materials, and my be designed as a cylinder, a frame work, or other solutions or combinations of solutions, adapted to the remaining elements of the wind power plant and the local conditions. The invention may also be used on land, on shallow waters and in deep waters. In deep waters the wind power plant may be afloat, and may have adjustable buoyancy and/or load and a self-erecting moment. The turbine may be a downwind turbine. It may have a fixed or variable, or cyclic pitch and define a circular plane of revolution, defined by the radial extension of the turbine blades. The turbine is adapted to yawn to a position substantially perpendicular to the direction of the wind. At least three wires (backstays, struts, cables, ropes, chains, a combination of these or other devices that are suitable to be loaded with tensile force) are attached to the tower or the machine housing at one end, and in at least one attachment point at the other end to hold the tower in an erected position in operation. Each wire may adopt at least a first and a second position, where the wire in the first position, at substantially the upwind side, extends downwards at an inclined angle from an attachment point in or adjacent to the centre of the forces that are applied to the tower by the turbine in operation; and in the second position, on substantially the downwind side and possibly on the right and left side of the tower, depending on the number of wires, the wires are led out of the plane of revolution, such that the turbine can yaw around a vertical axis without one or several wires being obstructive. This may be achieved in that each wire's effective attachment point on the tower is lowered away from the turbine plane, or in that the wire is allowed sufficient slack such that it hangs substantially straight downwards along the tower; sufficiently far down such that the wire not obstructs the turbine. To stabilize the wire at the lower position, it can in the first case be tightened, for instance in that it is pulled inn towards the lowered attachment point. The wires may also adopt intermediate positions as needed.

The wind power generator may be placed in a body of water, and its lower part may include one or several floating elements and a ballast such that it can float in an erected position in the body of water without tensioned wires.

The wires may be attached with its lower end to the bottom of the body of water and at least one further wire may be attached to the substantially lower most point of the wind power plant at one end and to the bottom of the body of water at the other end.

The entire or parts of the tower of the wind power plant may include two columns that are placed at each side of the vertical central axis of the tower, such that the wind turbulence from the columns at the predominant direction of the wind substantially meets the turbine to the side(s) for a vertical line through the hub of the turbine.

The entire or parts of the tower of the wind power plant may be yawed with the turbine around a vertical axis.

The entire or parts of the tower of the wind power plant may be equipped with fairings that reduce the resistance to flow in air and/or water.

The wires may be brought between the first and the second position with a mechanism including at least two controllably driven drums connected to the tower. At least two pulleys can be connected to the tower and be placed at a distance in the longitudinal direction of the tower from the drums. Adjustment wires with a length, secured to the controllably driven drums can run over the pulleys and back to the controllably driven drums. The wires may be attached a place along the length of the adjustment wires, such that operation of the controllably driven drums will lead adjustment wires in the longitudinal direction of the tower and can thereby elevate or lower the attachment point of the wire in relation to the longitudinal direction of the tower.

The wires may alternatively be brought between the first and the second position with a mechanism including at least two controllably driven drums connected to the tower. Adjustment wires with a length, can bet attached to the controllably driven drums and the adjustment wires may be attached a place along the length on the wires such that the adjustment wires can pull the wires in towards the tower.

Alternatively, the wires may be attached in the tower through skids or carriages running in recesses or tracks along the tower for elevating and lowering the wires. The slides can be driven by common linear actuators, chains or the like.

Furthermore, the invention includes a method for operating a downwind wind power plant with a wind turbine and wires with a variable attachment point. The wires may adopt upwind and downwind positions when the power plant is operating. The method includes steps for moving the attachment wires from a first upper position in the tower of the wind power plant to a second, lower position, yaw the wind turbine around a vertical axis, and move upwind wires from a first position when the turbine plane is adjusted substantially perpendicular to the direction of the wind.

The attachment wires can be tightened in its second, lower position.

The attachment wires can be tightened in their first, upper position.

The invention will herein below be described in detail by means of figures where:

FIG. 1 shows a fundamental embodiment with wires down to three points in the surface.

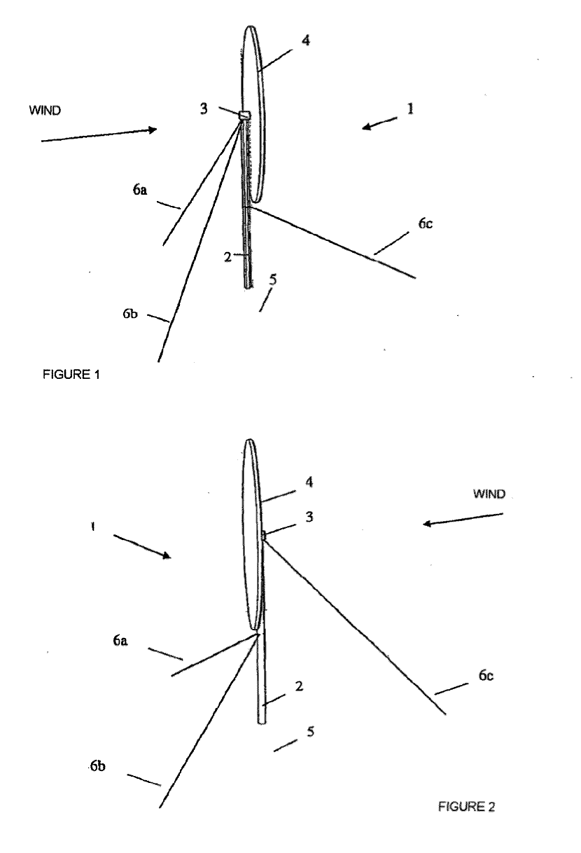

FIG. 2 shows the same embodiment as on FIG. 1, with a changed direction of the wind.

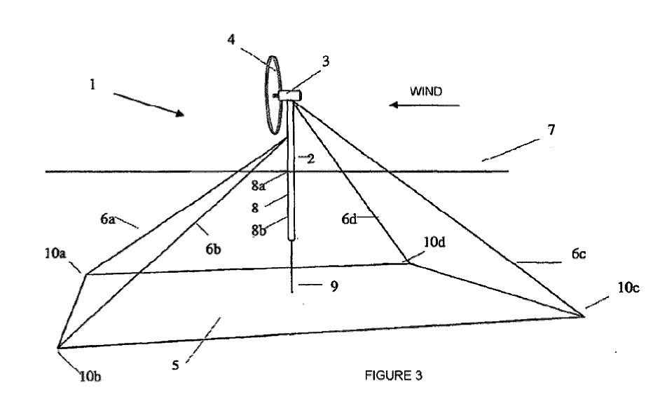

FIG. 3 shows a floating wind power plant, anchored to a seabed.

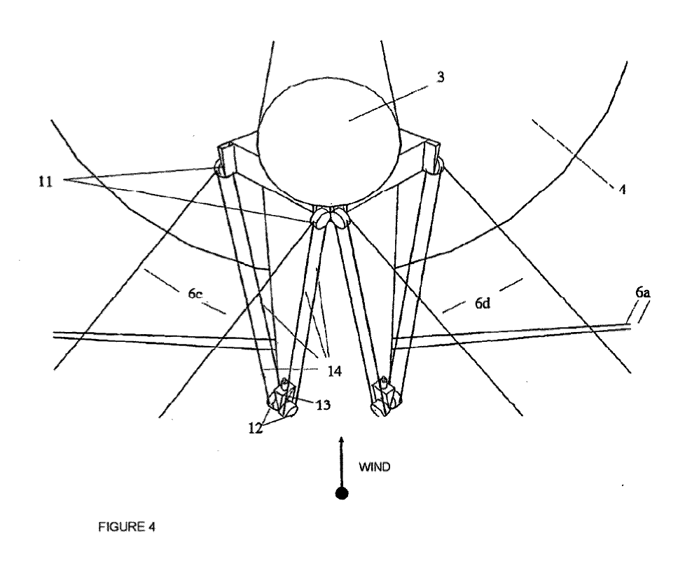

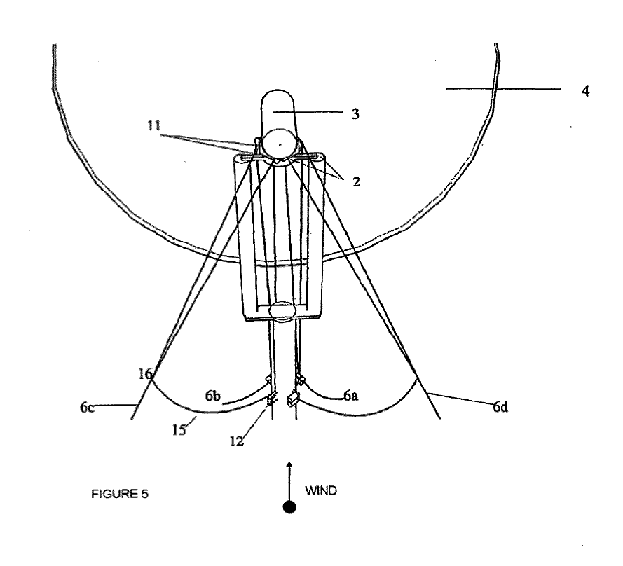

FIG. 4 shows a suggestion for an embodiment of a mechanism for moving the wires between an upper and a lower position.

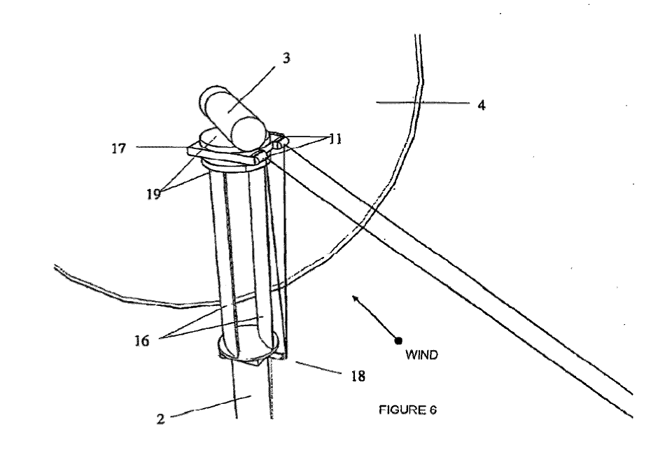

FIG. 5 shows a wind power plant with a two part tower that is fixed in relation to the surroundings.

FIG. 6 shows a wind power plant with at two part tower that can yaw with the turbine.

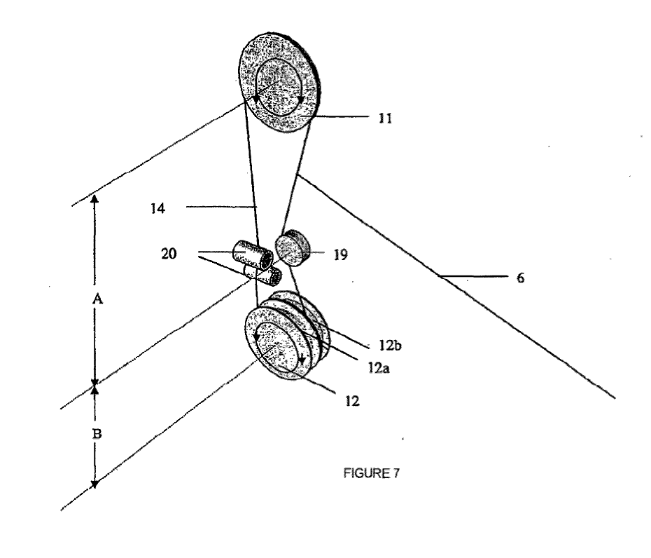

FIG. 7 shows a mechanism for moving and tightening the wires.

On FIG. 1 is a wind power plant 1 shown, including a tower 2, a machine housing 3 with a turbine 4 and other equipment (not shown on the figure) for operating the wind power plant. The machine housing 3 can be revolved or yawed around a vertical axis, such that the turbine plane at any time can be held perpendicular to the direction of the wind. In the figure it is shown the swept area of the turbine, the turbine plane, and not the single turbine blades. The tower 2 is attached to the surface 5. Wires 6a, 6b and 6c are attached at its upper end in the tower and at its lower end to the surface 5. The wind blows from the left, and upwind wires 6a and 6b are led up to its upper position, such that they from there can transfer the forces down to the surface. The wire 6c is led to its lower position for not being in conflict with the turbine 4. In this position the wire 6c extends downwards from the tower with a horizontal component of direction substantially at the direction of the wind, and will to a small extend take up forces of importance for the stability of the wind power plant.

In FIG. 2 the embodiment of FIG. 1 is shown, but now with the wind from the right side. This mode of operation is not entirely analogue with what is shown on FIG. 1, as only one wire 6c now is situated upwind and in an upper position. The wires 6a and 6b, now in a downwind lower position, are tightened to contribute to sideways stability.

On FIG. 3, such a wind power plant 1 is shown floating at the surface of a body of water, for instance the ocean. The tower 2 is led from the surface of the water 7 and further down into the water, where its underwater part 8 includes floating elements 8a and possibly ballast 8b. The wires 6 may be attached at its lower end to the bottom of the body of water 5, for instance the seabed. Further at least one wire 9 may be attached to the tower substantially at the lowest point 8b at one end and to the bottom of the body of water at the other end. By biasing this wire, possibly in combination with a slim embodiment of the tower 8 in the part effected by waves, it will be possible to limit the vertical motion that is caused by the motion of the waves.

On FIG. 3 the wind comes in oblique from the right. Two downwind wires 6a and 6b are therefore in a lower position. The two upwind wires 6c and 6d are in the upper position to accommodate horizontal and vertical forces, and thereby also to contribute to sideways stability. In such an embodiment an erecting moment of the wind power plant can be limited to a minimum necessary to achieve stability when the wind power plant not is in production, for instance during wire breakage, such that the joint weight is maintained low. At suitable sea depths can several wind power plants be placed in parks, anchored to an internal distance that makes it suitable to share anchoring points. On FIG. 3 it is in perspective view suggested a quadratic segment at the bottom of the body of water for instance the seabed, where upon each of the four corners may constitute an attachment point 10a, 10b, 10c and 10d for the suggested wind power plant and further three other adjacent wind power plants. If one also uses anchoring of the lower most point of the tower, it will in the central part of such a park only be necessary with two extra anchoring points for each additional wind power plant.

At deep waters it will be less appropriate to attach the lower part of the tower 8b at the bottom of the body of water, for instance the seabed. Thereby will the structure have a limited moment for controlled motion in yaw; the revolution of the turbine around a vertical axis. To contribute to grater moment it can be extended two or several wires from one or several attachment points at the bottom of the body of water. Wires from the same point at the bottom is then attached at each side of the vertical axis of the tower.

On FIG. 4 this is shown in a further embodiment of a floating wind power plant, with a perspective drawing of the upper part of the tower and parts of the turbine. The references to the seabed correspond to the previous figure (FIG. 3). FIG. 4 is more over shown in downwind direction, and also shows an embodiment of a mechanism for moving the wires from an upper to a lower position: The machine housing 3 with the turbine 4 is placed at the upper part of the tower 2, where upon it can rotate around a vertical axis. From each of the four attachment points 10a, 10b, 10c and 10d at the seabed (in FIG. 3) it is extended two wires —6a, 6b, 6c and 6d respectively up to the upper part of the tower 2. In that the two wires from each point is led up to each side of the tower it is established a possibility for transferring moment for yaw control, in that the anchoring forces are distributed asymmetrically to the two wires. Alternatively may one wire be extended from each attachment point 10a, 10b, 10c and 10d—and split to two wires, that thereafter are attached at each side of the central axis of the tower as shown. For each wire 6 that is attached to the tower, it has been included a mechanism for moving the positions of the wire, comprising an upper passive drum 11 and a lower, motor driven drum 12 with a motor/gearbox 13. Motor/gearbox may be of a conventional design, with hydraulic, pneumatic or electric propulsion. A separate wire or adjustment wire 14 is attached at its one end in a lower drum, is coiled some windings around this, for then to be thread around the upper drum 11 and down again to the lower drum 12, where it is wound a couple of times and attached. The wires 6c are attached to the wires 14 and follows along this up and down, in addition to in, onto the lower drum when the motor/gear 13 is operated at a sufficiently long period in one direction of revolution. This gives the possibility for moving the wire 6c between the upper and lower position, and also gives the possibility for tightening the wire 6c in both positions. The number of windings at the ends of wire 14 on the drum 11 and the drum 12 determines how much the wire 6c can be tightened in the upper and lower position respectively. The force and the stabilizing effect that is achieved by tightening wire 6c will more over be dependent on amongst other things elasticity and length of the wire. In the figure the lower drums 12 for both wires 6c attached along with common motor/gear 13 is shown. If it is desirable that the wires shall give a greater moment for yaw control in the lower position, the drums 12 each with a corresponding motor/gear 13 may be placed at each side of the axis of the tower, as shown for the upper drums 11. To provide moment to yaw control may possibly the two drums 12 tighten the two wires 6c in the upper position independently of each other. The design of the drums must be adapted in terms of flanges, choice of materials and size—to the type of wire and the loading situations. Correspondingly, it may be relevant to include leading pulleys that stabilizes the wires in a vertical and horizontal direction. The control of the wire positions is coordinated with yaw control, such that the turbine not can be yawed to a position where it can be in conflict with a wire at the upper position. This may in its simplest form occur through a conventional interlocking mechanism, but can more appropriately be integrated in a control system for the entire wind power plant, where all the wires, yaw control, brakes and possibly the control of the azimuth position of the turbine in parked condition is coordinated—and related to measurements of wind—and wave-heights, in addition to a predictive model of weather that possibly can receive data from sensors attached to the wind power plant or from other sources, for instance satellite measurements.

The entire or parts of the tower of the wind power plant may include two columns that are placed at each side of the vertical central axis of the tower. The tower can either be fixed in relation to the surroundings, or may pivot with the machine housing and the turbine. The tower structure can in the first case be oriented such that the wind turbulence of the column at the prevailing direction of the wind substantially meets the turbine to the side(s) for a vertical line through the hub of the turbine. This can reduce the dynamic loads of the turbine, as the turbulence not will meet each single turbine blade at the full radial extension at the same time. Instead the effect of the turbulence will happen at limited area of the turbine blade, and wilt move outwards in relation to the blade and in again—once per revolution.

FIG. 5 shows an embodiment with a fixed, two-part tower. The machine housing 3 with the turbine 4, is placed on the upper part of the tower 2, whereupon it can rotate around a vertical axis. The horizontal extension of the machine housing 3 must in this embodiment be somewhat greater than with a simple tower structure, such that the turbine must pass the wider cross section of the tower 2. The figure furthermore shows a mechanism for moving the wires between the upper and lower positions: From each of the four attachment points 10 a, 10 b, 10 c and 10 d at the sea bed (as shown in FIG. 3) it is extended a wire, 6a, 6b, 6c and 6d respectively, that is split in two at point 16 before it is attached to the drums 11 at the upper part of the tower 2. For each wire 6 that is attached to the tower it is included a mechanism for moving the positions of the wire, including an upper motor driven drum 11 and a lower motor driven drum 12. A separate wire 15 is attached to an anchoring wire 6c where it is split into two, at point 16. By moving wire 6c from the upper to the lower position, the tension in the split wires is removed out from the motor driven upper drums 11, whereas the lower motor driven drum 12 tightens in the wire 15, that thereby pulls wire 6c towards the tower, into the lower position, such that the plane of the turbine can be pivoted.

Either the tower substantially is of a conventional type, or if it includes two columns, the entire or parts of the tower of the wind power plant may be made such that it (the tower) revolves/yaws with the turbine around a vertical axis. A turbine that follows a tower with two columns in the pivoting around a vertical axis can then be orientated such that turbulences at any time and at any direction of the wind give the smallest possible load on the turbine. To allow the anchoring wires to be held orientated in its fixed directions, towards the anchoring points, they may be attached in rims that not follow the pivoting of the tower around a vertical axis.

FIG. 6 shows such an embodiment. The turbine 4 and the machine housing 3 are attached to a cylindrical element 19 that forms the upper part of a two-part tower segment 16, and that revolves/yaws along with this. The circular element 19 is surrounded by a rim 17 that provides attachment for the upper drums 11. The lower part of the tower 2 has a fixed orientation, and does not follow the turbine 4 and tower segment 16 during yaw. At the upper part of the lower part of the tower 2, the lower drums 18 are attached. During yaw of the turbine, the two-part segment 16 will thereby follow along, whereas the rim 17 with upper drums and the lower part of the tower with the lower drums will remain fixed. The figure does not show details of the mechanism for moving the wires between the upper and lower position.

Several other mechanisms can be used to shift the attachment wires between the upper and lover position. The simplest ones may be passive, in that the wind power plant is allowed to move in the direction of the wind, such that the downwind wire is given more slack until it can be pulled out of the upper positions, for instance through weights. This and other similar solutions may however in some situations give a limited safety, and will not give any opportunities for controlling the anchoring forces through tightening in the lower position. A detail of an embodiment that gives control with attachment forces both in the upper and lower position is sketched in FIG. 7. An upper passive drum 11 is placed at the top of the tower 2, close to the hub height of the turbine. A lower, two-part motor driven drum 12 is placed below the lowermost point of the turbine plane. A separate wire 14 is tensioned with one its ends in one part 12a of the lower drum, is wound a couple of times around this, for then being thread around the upper drum 11 and down again to the other part 12b of the lowermost drum 12, where it is wound a couple of times and attached. The end of the attachment wire 6 is fixed to the wire 14 and follows with this up and down. From the shown position in the figure, the wire 6 will be pulled towards an upper position by operating the lower motor driven drum in a direction of revolution against the clock. Vice versa it will be pulled towards the lower position in that the wire 14 is operated in a clockwise direction. In the last mentioned case, will the passive drum 19 define the height on the lower position for wire 6, even if wire 14 is tightened further in the clockwise direction. The purpose of including drum 19 is partly to be able to determine the lower position independently of the position of the motor driven drum, partly to be able to tighten the wire in the lower position also with wire solutions where the joint between the wire 6 and the wire 14 is to sensitive to be wound several turns on a drum. In this way, the distance B will define the length that can be tightened after the joint between the wires 6 and 14, without allowing the joint between the two wires to be wound onto the lower drum 12. The distance A should be approximately the same—or greater than the radius of the wind turbine. To ensure that the wire 14 enters the lower drum 12a tangentially, two adjustment drums 20 have been included. All the shown parts of the mechanism are attached to the wind power plant, for instance to the tower. The wire 6 is attached at its one end to the wire 14, and at its other end to an attachment point at the bottom of the body of water, for instance the sea bed. As a general solution, the mechanism will have a number of embodiments, where the placement of the main drums and support drums may be varied.

Wind and current will expose the floating wind power plant for horizontal forces over and below sea level. Either the wind power plant is in a production mode or not, the wind may impose horizontal forces on the structure that exceeds a critical level. To reduce these forces, the tower may be equipped with fairings: Towers that not can be revolved, can be equipped with fairings that passively or actively can be pivoted towards the wind such that the forces on the tower are reduced. By using pivotal towers, the fairings may be fixed to the tower.

In a corresponding way as the wind imposes the structure above water for considerable forces, great current velocities may lead to unwanted, horizontal forces on the sub-surface structure. To avoid unwanted conflicts between the size of the forces and the direction above and below water, the tower may include fairings below the waterline. These may be fixed if the tower can be pivoted with the direction of the current independently of the orientation of the turbine plane. In cases where the tower not can be pivoted with the direction of the current, the fairings may be free to revolve such that they passively can pivot toward the direction of the current. This presuppose that the vertical axis through the aerodynamic centre of the fairings is placed behind the axis of revolution for the suspension point of the fairings, seen in the direction of the current.

Yaw control of the wind power turbine can be performed with support in the moment that occurs through asymmetric sideways distribution of the forces that are taken up in the anchoring wires, but the turbine may also be equipped with a cyclic pitch control, such that the yaw motion (pivoting of the turbine around a vertical axis) can be performed or assisted by means of this.

1-11. (canceled)

12. A downwind power plant (1) with a tower (2), a machine housing (3) attached to said tower (2) and a turbine (4) supported in the housing (3), wherein said turbine (4) defines a plane of revolution and is adapted to be pivoted to a position substantially perpendicular to the direction of the wind, wherein at least three wires (6) are connected to the tower (2) at one end, and in at least one attachment point at the other end,
characterized in that:
each wire (6) individually may adopt at least a first upper and a second lower position in relation to a substantially longitudinal direction of said tower and in coordination with said position of said turbine (4);
wherein each wire (6) in the first position extends at an oblique angle downwards from an attachment point in or close to the centre of the horizontal forces that are applied to the tower by the turbine in operation; and
wherein each wire (6) in the second position do not obstruct yaw motion of the turbine, and is outside the plane of revolution of the turbine, such that the turbine is free to pivot towards the wire (6) in the second position without this wire (6) being obstructive.

13. The wind power generator according to claim 12 placed in a body of water, characterized in that its lower part includes one or several elements (8a) and ballast (8b), such that it can stay afloat in an erected position in the body of water without tensioned wires (6).

14. The wind power plant according to claim 13,
characterized in that wires (6) are attached at its lower end to the bottom (5) of the body of water and that further at least one wire (9) is attached to substantially the lowermost point of the power plant (2) at one end and to the bottom (5) of the body of water at the other end.

15. The wind power plant according to claim 12,
characterized in that the entire or parts of the tower (2) of the wind power plant (1) include two columns (16) that are placed at each side of the vertical central axis of the tower (2), such that the wind turbulence of the columns at the predominant direction of the wind substantially meets the turbine (4) to the side(s) of a vertical line through the hub of the turbine (4).

16. The wind power plant according to claim 12,
characterized in that the entire or parts of the tower (2) of the wind power plant (1) can pivot with the turbine (4) around a vertical axis.

17. The wind power plant according to claim 12,
characterized in that the entire or parts of the tower (2) of the wind power plant (1) is equipped with fairings that reduce the flow resistance in air and/or water.

18. The wind power plant according to claim 12,
characterized in that: the wires (6) are brought between the first and the second position with a mechanism including;
at least two controllably driven drums (12) connected to the tower (2);
at least two pulleys (11) connected to the tower (2) and placed at a distance in the longitudinal direction of the tower from the drums (12);
further wires (14) with a length, attached in the controllably driven drums (12) extending over the pulleys (11) and back to the controllably driven drums (12); and
wherein the wires (6) are attached a place along the length of the adjustment wires (14), such that operation of the controllably driven drums (12) will lead the adjustment wires (14) in the longitudinal direction of the tower (2) and thereby can elevate or lower the attachment point of the wires (6) in relation to the longitudinal direction of the tower (2).

19. The wind power plant according to claim 12,
characterized in that the wires (6) are brought between the first and second position with a mechanism comprising:
at least two controllably driven drums (12) connected to the tower (2);
further wires (14) with a length, attached to the controllably driven drums (12); and
wherein the adjustment wires (14) are attached a place along the length of the wires (6) such that the adjustment wires (14) can pull the wires (6) inn towards the tower (2).

20. A method for operating a downwind wind power plant (1) with a wind turbine (4) and wires (6) with a variable attachment point where the wires (6) may adopt upwind and downwind positions when the power plant is in operation wherein it includes the following steps:
moving the attachment wires (6) from a first upper position in the tower of the wind power plant (2) to a second, lower position;
pivoting the wind turbine (4) around a vertical axis; and
moving the upwind wires (6) from a second to a first position when the turbine plane is adjusted substantially perpendicular to the direction of the wind.

21. The method as defined in claim 20, wherein the attachment wires (6) are tightened in its second, lower position.

22. The method as defined in claim 20, wherein the attachment wires (6) are tightened in its first, upper position.

23. The wind power plant according to claim 13,
characterized in that the entire or parts of the tower (2) of the wind power plant (1) include two columns (16) that are placed at each side of the vertical central axis of the tower (2), such that the wind turbulence of the columns at the predominant direction of the wind substantially meets the turbine (4) to the side(s) of a vertical line through the hub of the turbine (4).

24. The wind power plant according to claim 14,
characterized in that the entire or parts of the tower (2) of the wind power plant (1) include two columns (16) that are placed at each side of the vertical central axis of the tower (2), such that the wind turbulence of the columns at the predominant direction of the wind substantially meets the turbine (4) to the side(s) of a vertical line through the hub of the turbine (4).

25. The wind power plant according to claim 13,
characterized in that the entire or parts of the tower (2) of the wind power plant (1) can pivot with the turbine (4) around a vertical axis.

26. The wind power plant according to claim 14,
characterized in that the entire or parts of the tower (2) of the wind power plant (1) can pivot with the turbine (4) around a vertical axis.

27. The wind power plant according to claim 15,
characterized in that the entire or parts of the tower (2) of the wind power plant (1) can pivot with the turbine (4) around a vertical axis.

28. The wind power plant according to claim 23,
characterized in that the entire or parts of the tower (2) of the wind power plant (1) can pivot with the turbine (4) around a vertical axis.

29. The wind power plant according to claim 24,
characterized in that the entire or parts of the tower (2) of the wind power plant (1) can pivot with the turbine (4) around a vertical axis.

30. The wind power plant according to claim 13,
characterized in that the entire or parts of the tower (2) of the wind power plant (1) is equipped with fairings that reduce the flow resistance in air and/or water.

31. The wind power plant according to claim 14,
characterized in that the entire or parts of the tower (2) of the wind power plant (1) is equipped with fairings that reduce the flow resistance in air and/or water.
